(19) United States
(12) Patent Application Publication
(10) Pub. No.: US 2014/0126679 A1
(43) Pub. Date: May 8, 2014

(54) RENEWABLE ENERGY PRODUCTION PROCESS WITH A DEVICE FEATURING RESONANT NANO-DUST PLASMA, A CAVITY RESONATOR AND AN ACOUSTIC RESONATOR

(71) Applicant: György Egely, Budakeszi (HU)

(72) Inventor: György Egely, Budakeszi (HU)

(21) Appl. No.: 14/116,638

(22) PCT Filed: May 7, 2012
(86) PCT No.: PCT/HU2012/000034

§ 371 Date: Nov. 8, 2013

(30) Foreign Application Priority Data
May 11, 2011 (HU) P1100247

(51) Int. Cl. G21B 3/00

(52) U.S. Cl. CPC G21B 3/00
USPC 376/156

(57) ABSTRACT

The invention is a renewable energy production process with resonant nano-dust plasma, with the application of a cavity resonator and an acoustic resonator. During the process the acoustic resonator is placed inside the cavity resonator, and create a series of acoustic resonances with a complex plasma made of sub-micron sized carbon dust, hydrogen isotopes and other gases between 10 Pa and 500 kPa at about 2.000° C., thus creating oscillations and thus plasmon polaritons on the surface of carbon dust particles oscillating between 10 kHz-5 GHz and in the terahertz range, which in turn produces heat or electric energy, or creates a series of nuclear transmutations. The invention is an embodiment producing renewable heat, formed by a cavity resonator (30) excited by electromagnetic fields, and an acoustic resonator (10). In the acoustic resonator (10) operated with a number of acoustic resonances, there are nano-sized dust particles (1). The electromagnetic cavity resonator (30) is cylindrical, spherical or rectangular with mirror-like internal walls (31), inside of which the cylindrical or spherical acoustic resonator (10) suitably made of heat resistant and electrically insulating material is mounted.

The subject of the invention is an energy production process with resonant nano-dust plasma, with a cavity resonator and an acoustic resonator. It is also a heat production device, which consists of an electromagnetic cavity resonator and an acoustic resonator driven by a series of acoustic resonances of plasma oscillations of nano-sized dusty particles. The device produces electric energy and is driven by resonant, nano-dust plasma of spherical symmetry. It comprises a power supply, an oscillator driving primary and secondary circuits, driving the armature of a cathode and an anode. There is also a distributed parameter device, which consists of a magnetron or a resonant electromagnetic circuit containing an acoustic resonator. This acoustic resonator features nanometer-sized dust particles embedded in plasma.

It is known that CO₂ is produced during the combustion of carbohydrates, while releasing heat. This chemical reaction is a fundamental process in technology. Fire is among the first inventions of mankind and an indispensable part of our civilization. Unfortunately, however, all resources are finite, and CO₂ has a greenhouse effect. Its emission into the atmosphere has an adverse impact on Earth's climate, causing widespread instabilities.

Although CO₂ dissolves in water and is utilized by plants, recent climate observations have shown that, due to its increasing concentration, temperatures and precipitation have become erratic. Therefore, there is a need for novel energy sources, and for an overall reduction in atmospheric CO₂. This is possible only by new energy producing processes.

Theoretical and experimental results over the past few years have opened up new vistas by leveraging electroweak interactions hitherto considered impractical. While nuclear reactors and hot fusion devices are based on strong interactions and always emit some radioactivity, nuclear reactions—based on electroweak interactions and resources always available and thus renewable—do not harm the environment and are economical to operate. Our invention has realized this goal by focusing on the useful properties of dusty or complex plasmas.

Solutions known so far have applied nano-sized nickel or palladium metal grains at working temperatures of 300-600° C. and by the dispersion of light or heavy hydrogen. Two researchers at Osaka University; Joshiaki Arata and You Chang Zhang, have observed heat generation for months in a container filled with nano-sized palladium dust, heavy hydrogen gas with ZrO₂ catalyst above 100 bar pressure. Since nano-sized palladium dust is expensive, they did not patent their process. Reference: Clarke B. et al: Search for ³H and ⁴He in Arata-style palladium cathodes, part II. Fusion Science & Technology. Vol 40, pp 152, 2001.

Researchers at the University of Bologna in Italy have applied for patent (WO2009/125444A1) for their process based on nano-sized Ni dust and hydrogen, though the catalyst itself has not been disclosed. Here, Ni isotopes and light hydrogen turn into copper by yielding a large amount of excess heat.

Three researchers at Mitsubishi were awarded Japanese patents JP2001201875; EP1202290A2, 2002 for a similar process yielding heat and transmutation; they used nano-sized palladium dust and a carbon electrode. This process took place at room temperature.

In the processes described above the temperature does not exceed the threshold of plasma formation—about 600° C. Therefore, unlike in our process, they did not use complex resonant plasma, even though the final result is the same: a large amount of heat generation as the outcome of nuclear processes.

Our invention was accomplished by the combination of nano-sized and quasi-particles. Both areas are under intense investigation independent from one another. Their combined application has not been utilized so far.

The use of nano-size matter is interesting in itself, as the macroscopic laws are no longer valid here, and the quantum rules are not yet valid either. For example, nano-sized gold particles take part in chemical reactions, and several materials have different magnetic and electric properties in this range. Some solid materials become liquid at room temperature. The reason for this change is that surface-to-volume ratio changes significantly.

Quasi-particles like the “n” or “p” type holes in semiconductors have brought about significant advancements in the world of electronics. Plasma containing nano-sized dust has been important for quite some time, but high-amplitude (resonant) plasma has not yet become widespread in the industry.

In our process, nano-sized dust particles oscillate in plasma, where the average temperature is about 2,000° C. This way, a partially ionized, non-equilibrium, high-amplitude plasma is created, with self-organization properties. Here, some of the electrons approach the speed of light due to the effect of plasma Wakefield acceleration, to be described later.

The energy of plasma ions (like O⁺; N⁺) might exceed 10⁶ eV at and around maximum amplitudes, and upon their impact into dust particles. The individual energy of dust particles might be upwards of 100 eV.

The dust plasma oscillation phenomenon is termed DAW (Dust Acoustic Waves), but it has not yet been investigated at the extreme parameters we used.

High-amplitude plasma oscillations of multiple frequencies help the energy production processes, because (for a short period) not only the electrons have high potential and kinetic energy, but the ions and dust particles do too. The amplitudes of the oscillations, the average plasma temperature could be increased until the dust particles evaporate; this is one of the technology's upper thresholds. At these parameters, there is a significant amount of energy being generated on the surface of the particles, where the ostensible mechanism will be described later.

Therefore, in addition to heat production, plasma-chemical processes take place by letting fine-grain waste materials into the oscillating plasma for transformation (like galvanic sludge or other dangerous waste), but one may break up the bonds of H₂O molecules or CO₂ molecules into carbon and oxygen.

This novel type of plasma has been given several names including complex plasma, dusty plasma, crystal plasma or colloid plasma.

This is distinguished from the usual plasma containing the mixture of ionized and neutral gases: it contains solid particles of sub-micron size. Thus we obtain new and technically useful properties. Compared to methods known up to now, the most useful property is that the plasma state can be sustained with the smallest possible investment of energy, and the so-called plasmon polariton quasi-particles make possible further processes which are technically useful but hitherto have not been utilized.

These surface plasmon polariton processes are described in some monographs, for example, Stephen A. Maier: Plasmonics. Fundamentals and applications (Springer, 2007), or Droir Sarid, W. Challener: Modern Introd. To Surface Plasmonics, Cambridge Univ. Press, 2010.

It is known that the partial ionization of gases and vapors starts at atmospheric pressure and at about 1,000° C. Full ionization starts at a relatively high temperature of 10-20,000° C. for one and two-atom gases, but for longer chains this value can be higher (as described by the Saha equations). It is possible to achieve such high temperatures by high energy density power supplies at atmospheric pressure, but with a considerable loss of energy due to the cooling effect of walls.

In the process and devices we developed, considerably less energy is required for the plasma state to be ignited and sustained.

In the dusty or complex plasma we have developed, nuclear processes take place with the help of tuned acoustic and electromagnetic resonances at low atmospheric pressures up to 2-3 bars, thus gaining useful extra energy compared to the input energy. A considerable field amplification process takes place on the surface of dust particles, which is one of the bases of our processes. The local electric field can be amplified up to 10⁴⁸ times on the surface of micron and nanometer-sized particles. (Details are in Kathrin Kneipp, Physics Today, 2007, Nov, pp40, or Mark I. Stockman: Nano Plasmonics. Physics Today, February 2011, pp39-44.

All the amplification processes are useful in technology, as in the case of optical focusing lenses or condensers.

Dust particles oscillating in the plasma with high amplitude boast high-intensity electric fields due to their movement (plasma Wakefield acceleration) at frequencies ranging from 10 Hz to 50 GHz, partly due to infrared and visible EM radiation with characteristic frequencies in the order of terahertz wavelength. However, these high frequencies do not pose any problem, as the relaxation time of electron clouds (groups) on the surface of the particles is at 10 femtoseconds, and polarization takes even shorter, 100 attoseconds.

It is worth utilizing these possibilities. This amplification effect is commercially exploited today, however, not in oscillating plasma, but for optical amplification and biological tests, like those of immune reactions.

The feasibility of the technical application of the plasmon polaritons on the surface of electrically conductive nano-sized particles has been noticed by two US physicists, Lewis G. Larsen & Allan Widom, both researchers at Northeastern University. They realized the possibility of the e⁻+p⁺→n+v reaction due to this field amplification, meaning that the combination of an electron and a proton could yield a neutron and a neutrino. (Their paper: “Ultra low momentum neutron catalyzed nuclear reactions on metal hydride surfaces.” Eur. Physics J. C Vol.46, March, 2006, pp107. They suggested nano-particles embedded into palladium surfaces, at room temperature as a technical solution. They have filed for two patent applications; USO296519A1/2008 and USO232532A1/2008.)

The process of our invention differs from their solution in that they use solid/liquid medium and palladium/light hydrogen with electrolysis at room temperature. Our invention has an average temperature of about 2,000° C., though it has a highly non-equilibrium distribution in a resonant complex plasma consisting of carbon particles. From a technical aspect, this is more advantageous, as we amplify the resonant amplitudes and, with the elevated temperature, the effect of infrared radiation is further strengthened. Thus, the Widom-Larsen-type process we use is more efficient, because the surface of the dust particles is larger for a given volume than that of the usual cold fusion. We use a more intensive electric field amplification and have more free protons due to the higher-temperature plasma of about 2,000° C.

The neutrons created in the Widom-Larsen theory can participate in several nuclear processes while producing energy. As an example, we show a chain of pertaining reactions where fusion with neutrons increases the mass number of a carbon nucleus while releasing energy. This is shown below, between two carbon isotopes. The number above the arrow shows the amount of released energy, and the text under the isotope indicates whether it is stable or not, and the number under the arrow means the halving time of the isotope.

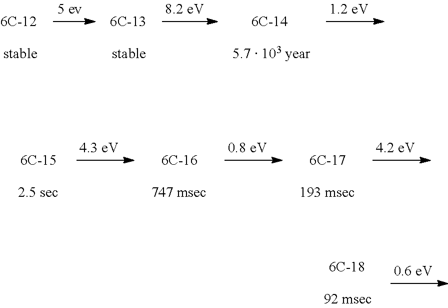

The unstable carbon isotopes may turn into stable and unstable isotopes of nitrogen, which in turn yields energy again. However, even after emitting an alpha particle it will turn into a stable carbon isotope. Therefore, closed cycles are formed, which we have observed during our experiments. The process is regarded as renewable due to the closed nuclear cycles.

Due to the nuclear cycles, there are a number of heat producing cycles as well. As a consequence of electroweak interactions, there is no significant y radiation as one would expect with strong nuclear forces, due to hot fusion reactions. Therefore our process is based on “textbook physics.” This achievement is new and has not been done before. The above-mentioned chain of reactions takes place on the surface of a cloud of carbon dust particles oscillating with high amplitude via a chain of neutron captures. The protons necessary for this process are produced by splitting a small number of H₂O molecules. The plasma, containing mainly the molecules of air, will thermalize the water and then ionize it at this temperature.

Some of the hydrogen ions will be attracted as protons to the negative carbon particles and together will form neutrons as a consequence of the Larsen-Widom model according to our hypothesis. Most probably all hydrogen isotopes are capable of this process, but their reaction probabilities are strongly dependent on their velocity.

Our process works with light hydrogen nuclei, according to our experience.

One of the fundamental discoveries of the invention has been that the surface of nano dust particles in resonant, complex plasma is suitable for the electric field amplification process. Thus, the e⁻+p⁺→n+v reaction means the creation neutrons from electrons and protons. The ultra-cold reactions, created this way, take part in energy-creating nuclear process, which are usually a self-sustaining process.

Our process might take place in nature as well. For example, in the corona of the sun, which, with temperatures reaching several million degrees C., is much hotter than the surface that merely averages 6,000° C.

The diluted, cold interstellar plasma might produce energy as well, this is what has been labeled as “dark energy.” It has been known for some time that interstellar, oscillating plasma is dusty. (Eg. Szalai Tamás: “Supernova, producing dust.” Fizikai Szemle, December 2010, pp 339) It is known that interstellar plasma contains dust particles of Si, C and metal oxides, in micrometer-size grains, in a diluted plasma containing protons. Though our process requires some energy input, it is much less for a given volume than for other plasma processes, such as glow or arc discharges.

Plasma production by the usual methods without dust requires a higher energy input. Therefore, it was out of question to produce excess heat or split the molecules of CO₂. (More energy would be required than what can be gained on the shaft of an internal combustion engine.)

Our process is not of the “hot fusion” process based on the unification of deuterium and tritium at or above 800 million ° C., and also not the so-called “cold fusion” process, which is based on the electrolysis of a palladium cathode and a deuterium-rich electrolyte at room temperature, based on their strong nuclear interaction.

The economic heat producing process is applicable for the breaking of the bonds of CO₂ molecules or other chemical by-products. It is possible to break the O₂ gas molecule of an internal combustion engine in a closed cycle, as we are not obliged to use the 80% nitrogen content of air. (40% might be sufficient). Thus, the temperature of combustion could be increased, as there is no need to heat the neutral N₂ gas, since it does not participate in the combustion.

The Carnot efficiency of an internal combustion engine could be increased due to the improved temperature, which generates some excess mechanical energy. If the engine construction is modified—e.g. with ceramic cylinders—, the efficiency of Diesel engines could also be improved. Therefore, the overall efficiency of the process can be further improved, and even emissions of toxic wastes (like NOx) could be eliminated.

The carbon particles generated in our process as a by-product could be valuable materials for carbon fiber materials, or as a filling material for copiers, and the other by-product, water, is not harmful.

During the process, the CO₂ molecules should be split, but the carbon dust must not melt. This could be regulated by the plasma input power and frequency. Our energy production method utilizes and amplifies the vibration of the CO₂. Therefore, it is very important to be able to adjust both the frequencies and the amplitudes of the system. The favorable parameters are sought by measuring the ratio of CO₂/O₂, and the plasma is heated according to this ratio.

Our invention is described in the figures.

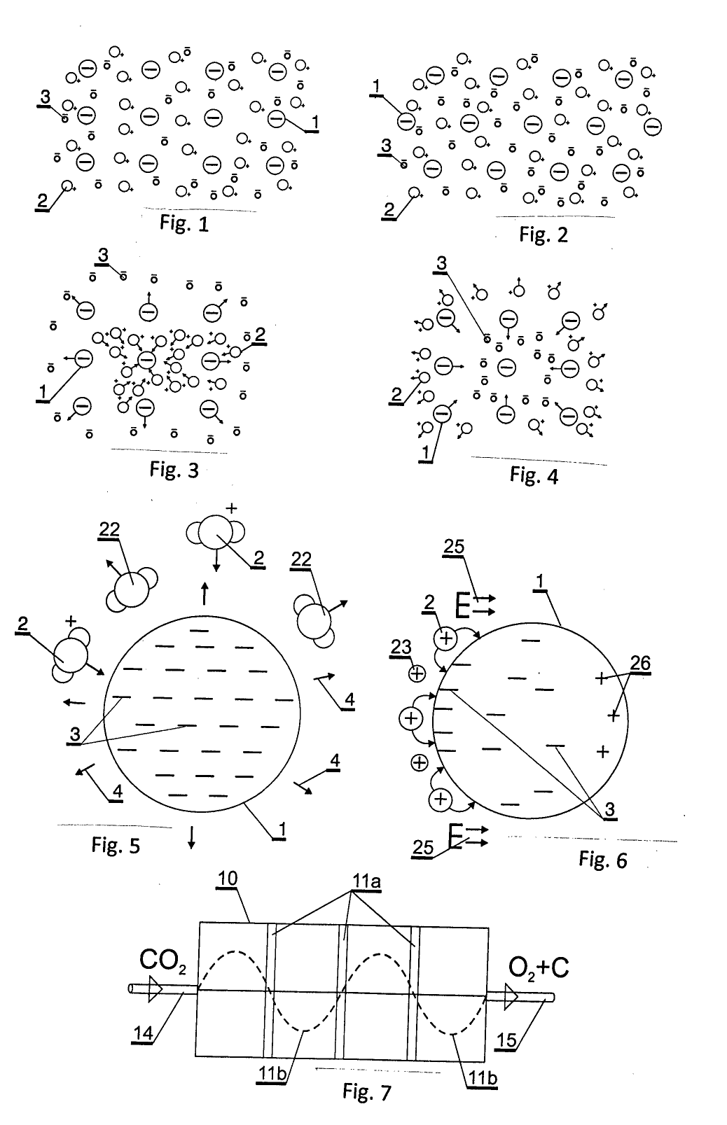

FIG. 1 is the schematic drawing of the dusty plasma without oscillation, in a plane, in equilibrium state.

FIG. 2 is also a quasi-solid plasma shown in a plane, where the dust particles are arranged on a hexagonal grid.

FIG. 3 The Dust acoustic wave (DAW) oscillation is shown along a plane.

FIG. 4 is the opposite phase of the oscillation, shown in FIG. 3 in that moment when the electrons are in the middle of grid and the positive ions are, on the perimeter of the crystal plasma dust particles.

FIG. 5 is the schematic portrayal of a negative dust particle and its immediate surroundings in a steady-state condition.

FIG. 6 is a schematic layout of a nano-sized particle with an external electric field.

FIG. 7 is a simplified picture of a cylindrical acoustic resonator, where the pressure of the ionized plasma is shown along the main axis.

FIG. 8 portrays an inductive solenoid, capable of exciting dusty plasma oscillations via high frequency electromagnetic fields.

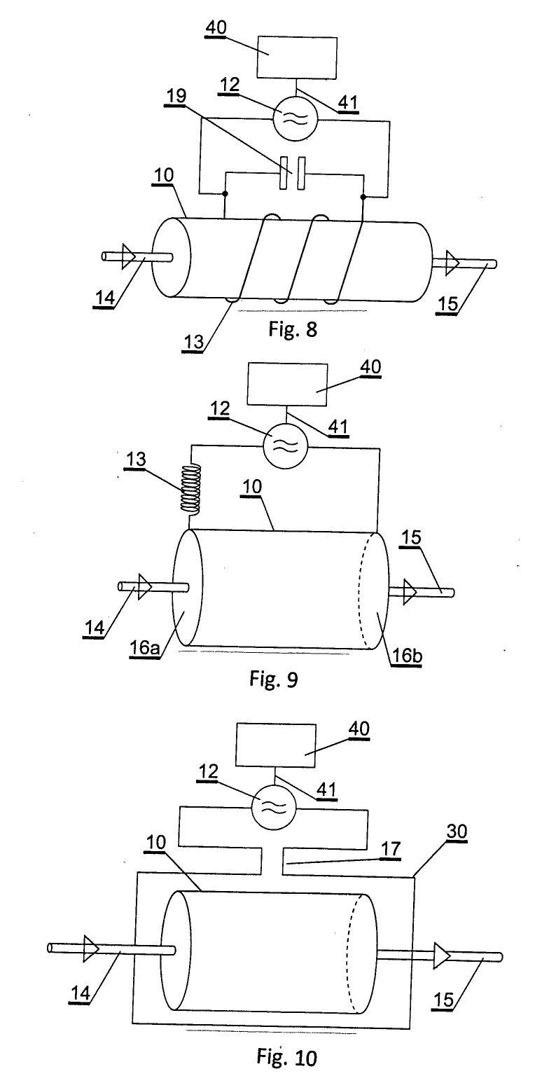

FIG. 9 portrays the circuit with a capacitive coupling to a dusty plasma.

FIG. 10 portrays the principle of a complex plasma excitation with microwaves.

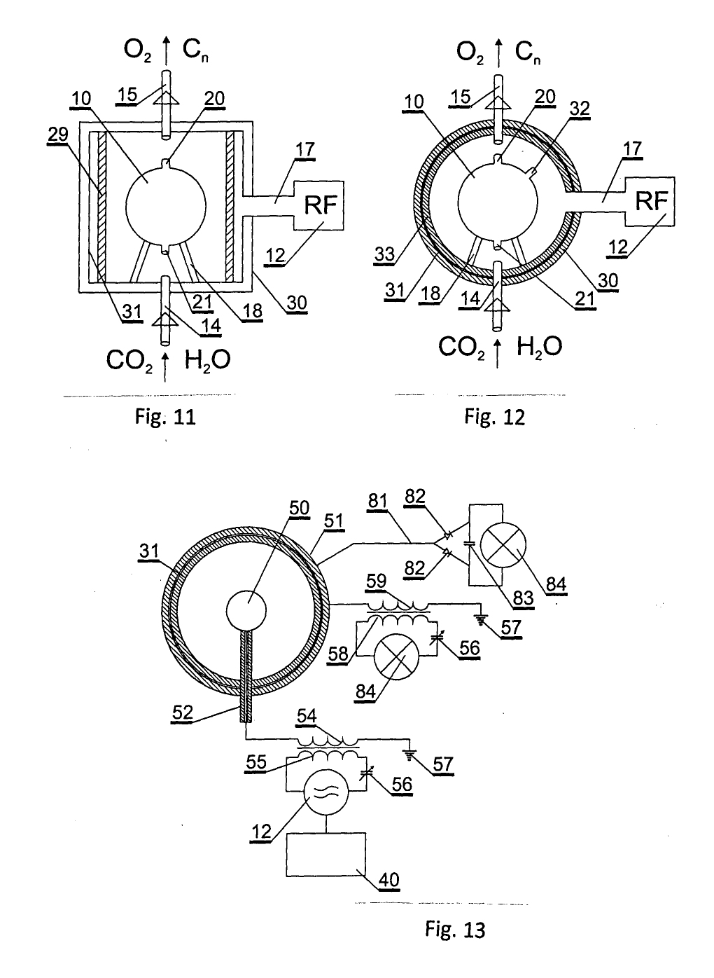

FIG. 11 is the schematic layout of the energy production device with a spherical acoustic and a cylindrical microwave resonator with microwave dusty plasma excitation.

FIG. 12 is a similar layout as shown in FIG. 11, but the electromagnetic resonator is spherical.

FIG. 13 is a schematic layout of a low-pressure device consisting of concentric spheres capable of producing electrical energy directly.

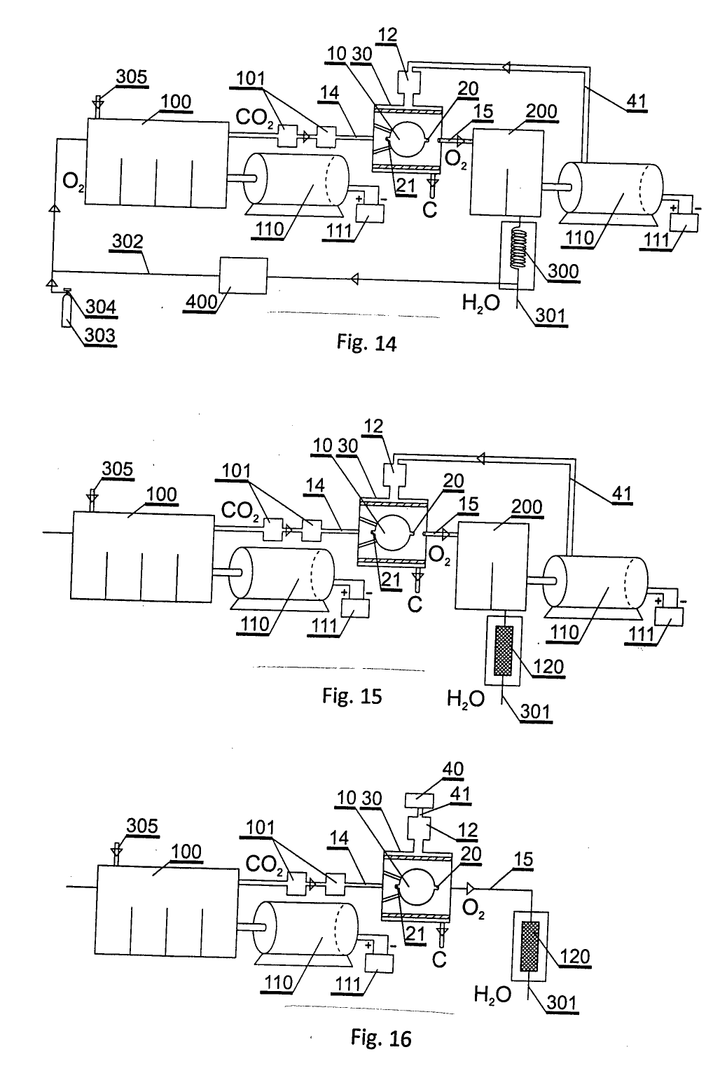

FIG. 14 is a schematic drawing of a CO₂ thermalizer, connected to a closed circle of an internal combustion engine.

FIG. 15 is similar to that of FIG. 14, but the O₂ content of the split CO₂ molecules is not reintroduced to the air intake pipe of an internal combustion engine.

FIG. 16 is a simple layout, when the exhaust CO₂ is thermalized, and emitted to the environment via a catalytic converter.

Before describing the technical layout of the invention, we outline the background physics to help to understand the most important effects.

According to FIG. 1, the scheme of dusty plasma is shown without oscillation along a plane, in equilibrium. The size of the negatively charged dust particles is the same (for the sake of simplicity), forming a square grid of the “crystal plasma.” The dust particles are in a quasi-equilibrium state. The average velocity of free electrons (3) is very high. Positive ions (2) are slower than electrons (3) but much faster than the dust particles (1).

In FIG. 2 a hexagonal-grid crystal plasma is shown along a plane. The positive ions (2) and electrons (3) are shown as well. Neutral atoms (and negative ions) are not shown for the sake of simplicity. There are several grids above each other, at a distance of half grid constant.

FIG. 3 is a dust acoustic wave (DAW) along a plane in that moment when most of the electrons are on the external perimeter of the dusty plasma, yet the dust particles (1) are still moving outside due to their high inertia. At this moment, positive ions (2) are accelerating already into the plasma.

The oscillation amplitude of dust particles (1) is very small compared to that of electrons (3). For the sake of simplicity, the external exciting electric field is not shown.

In FIG. 4 the opposite phase of the oscillation is shown in FIG. 3. At this stage, electrons (3) are in the middle of the grid, and positive ions (2) are on the periphery of the crystal plasma. Neutral molecules and atoms are not featured for the sake of simplicity. According to FIGS. 3 and 4, the complex plasma is not neutral during oscillations. Dust particles (1) do not move significantly compared to their position, shown in FIG. 3. Only the fundamental harmonic is shown. Higher-frequency oscillations are not shown for the sake of simplicity.

FIG. 5 portrays a CO₂ molecule near a dust particle (1), the latter having a negative electric field is in a steady state. The positive ions of a CO₂ molecule, its neutral state (22) is shown and the negative electric field vector (4) of a dust particle (1), where positive ions (2) are accelerating toward a dust particle (1). The positive ions (2) and neutral molecules (22) may collide and break apart before hitting a dust particle (1). For the sake of simplicity, the external exciting field is not shown. While the characteristic size of FIG. 3 and FIG. 4 are in centimeters, the dust particles are between 10-1,000 nanometers in diameter.

For the sake of simplicity, the charge distribution of carbon nano-particles of FIG. 5 is shown as homogeneous. This is true if there is no external exciting field, but it seldom occurs.

FIG. 6 is a more realistic portrayal of nano dust (1) in case of an external exciting field (25). It shows that the distribution of electrons (3) is not uniform on the surface of the dust particles (1), because an external field (25) will polarize it. This is a quasi-particle called plasmon polariton, characterized by high resonant field intensity. The positive local charge is created due to the lack of local electrons. The ionized O⁺ and N⁺ (24) positive ions (not fully ionized) and the fully ionized H atom, proton (23) is also shown sticking to the surface of dust particle (1).

Due to the temporally and spatially changing external field (25), there will be several oscillation frequencies and high electric field intensities inside and outside. Those oscillations on the surface are surface plasmon polaritons.

This portrays the field amplification capability of dust particles, which takes place between the positive ions of (24) and protons (23) and that of the negatively charged dust particle (1), or between the positive space charge (26) on one side of the particle and the electron cloud (1) on the other side of the particle.

FIG. 7 is a simplified drawing of a cylindrical resonator (10), and the plasma pressure is shown along the axis. The acoustic, longitudinal resonance is shown when the external exciting magnetic field is parallel to the cylinder. The maximum pressure locations (11b) and the crests (11a) are shown as well. The molecules to be broken apart (i.e. CO₂) flow into the cylinder through the inlet (14) and the carbon and O₂ leave via the outlet (15). The exciting electromagnetic fields are not shown for the sake of simplicity, but the main field is parallel to the axis of the resonator (10).

The inlets (14) and outlets (15) have different diameters and lengths and the oscillation frequencies of the acoustic resonator (10) could be influenced by choosing the proper size for the inlets (14) and outlets (15).

Our invention is a renewable energy production process with resonant nano dust plasma. The acoustic resonator is placed into an electromagnetic cavity resonator creating a series of resonators. In the acoustic resonator (10) we create oscillations in the wide spectrum of 5 Hz-5 GHz at amplitudes above 120 dB, in the pressure range of 10 Pa-500 kPa at temperatures ranging between 1,000° C.-3,000° C. The complex plasma contains sub-micron sized carbon dust particles at the hundred-nanometer scale with a total carbon mass of less than 0.5 g, in a gas of less than 1% mass of hydrogen isotopes and the rest of air, or in a mixture of less than 1% hydrogen and helium. The plasma is excited directly from an external power source, at a frequency of 5-15 GHz with an approximate power density of about 2,000 W/dm³. Power is reflected from the wall of the electromagnetic resonator. With the help of these plasma oscillations and resonant surface electric field amplification, we create surface plasmon polariton oscillations between 10 kHz-5 GHz and in the terahertz range, leading to nuclear processes generating heat and nuclear transmutations, or we could produce electric energy. Several different devices were developed to utilize this process. They will be described below along some advantageous applications according to our invention.

The renewable energy production device according to our invention consists of an electromagnetic cavity resonator (30) and an acoustic resonator (10). There are nanometer-sized dust particles (1) in the acoustic resonator (10), oscillating with a series of frequencies. The Cavity resonator (30) could be rectangular, cylindrical or spherical, with a smooth, mirror-like internal surface. The acoustic resonator made from heat resistant insulating material (10) is placed inside the electromagnetic cavity where the acoustic resonator has an input tuning opening (21) and an output (20) opening, with an axisymmetric shape, on an insulating stand. The acoustic resonator is surrounded by a transparent quartz glass tube (29), which is heated by electromagnetic waves through waveguide (17) by an oscillator (12) capable of generating electromagnetic waves above 1 GHz to reach about 2,000° C. in the plasma.

The renewable heat production device In FIG. 11 is essentially spherical. It consists of an acoustic. resonator (10) and microwave generating means. The acoustic resonator (10) is placed on a stand (18) made of an insulating material.

The CO₂ gas to be broken apart enters via the inlet (21) to the acoustic resonator, and the separated molecules leave the resonator via outlet (20) into a cylindrical or rectangular electromagnetic cavity resonator (30). The broken molecules and nano-dust particles leave the device via the outlet (15). Then, these micro-particles could be reintroduced into the device, or could be filtered from the exhaust gas. The electromagnetic waves from the oscillator (12) are guided via a waveguide (17) into the cavity resonator (30). The spherical resonator (10) exit tuning outlet (20) and inlet tuning outlet (21) usually have different diameters and lengths. An acoustic resonator (10) made of spherical quartz glass has an average diameter of 6 cm. Its inlet tuning (21) is 15 mm in diameter, and the outlet tuning (20) diameter is usually 5 mm diameter. It is 2-10 mm long, and the usual pressure is about 1-3 bar.

There is another form of our renewable energy generating invention, based on our process. This device consists of an electromagnetic cavity resonator (30) and inside it an acoustic resonator (10). There are nano-sized dust particles (1) in the acoustic resonator (10) oscillating by a series of resonances.

The cavity resonator (30) is spherical and contains a spherical acoustic resonator in a concentric-spherical array (10), shown in FIG. 12. The cavity resonator (30) has a fine polished metal internal surface (31) which is covered by a transparent heat resistant glass (33). The acoustic cavity resonator is made of heat resistant, electrically insulating ceramics, mounted on an insulating stand (18), having at least two or more tuning openings, an outlet (20) and an inlet (21). In the acoustic resonator (10) the pressure is usually at or above atmospheric conditions, and the spatial average temperature is about 2,000° C.

The invention shown in FIG. 12 is similar to that of FIG. 11, but consists of two concentric-spherical resonators. The metal electromagnetic cavity resonator (30) has an internal polished surface (31). The internal cover of the surface is made of a transparent, heat resistant glass (33). The acoustic resonator (10), where the plasma oscillator is set on a stand (18) made of insulating material. There are three tuning openings on the acoustic cavity resonator (10), namely openings (20), (21) and (32). The length and diameter of the tuning opening (32) is expediently smaller than the inlet tuning opening (21) and exit tuning opening (20)—preferably 3 mm in diameter and 1-2 mm in length. The inlet opening (14) and exit tube (15) allows the air, H₂O, CO₂ to flow through, or for the purpose of feeding the hazardous waste products via entering port (14) and removal port (15).

The process of our invention makes it possible to produce renewable electric energy, shown in FIG. 13. This consists of a concentric-spherical electrode and armature, and is powered by complex nano-dust plasma. The electrode is connected to a power supply. The armature is connected to a load (84). The power supply consists of an oscillator (12), primary (55) and secondary coils (54) and a power source (40).

The load (84) is connected to the armature via several oscillating circuits. The internal electrode (50) is made from carbon or carbosilicate. It is connected to a terminal of the secondary coil (54), via an electrical insulator (52), working in the kilohertz-megahertz frequency spectrum. The other terminal of the secondary coil (54) is connected to ground potential (57). The spherical armature has an internal, polished surface (53) made of insulating and heat resistant material. The pressure is about 20 Pa and the average temperature is less than 500° C. There are oscillating circuits connected to the armature via a single wire connection (polarization currents).

FIG. 13 is a low-pressure system, having concentric-spherical resonators, to directly produce electric energy. The device operates at low pressure (under 100 Pa). Therefore, it could be run under 200 MHz with discrete element oscillating circuits. This is the “single wire” Tesla-type arrangement based on polarization currents. The circuit is closed by capacitive displacement currents, so a single wire is sufficient. The inner electrode (50) is covered by carbon or carbosilicate. The external armature (51) is made of metal, covered internally by a layer of transparent dielectric with low polarization loss (53). The internal electrode (50) is excited by a secondary coil (54) via insulating material (52), while the other terminal of coil (54) is on potential (57).

The power is supplied from an electrical energy source (40) to an oscillator (12) via a tuning condenser (56) to a primary coil (55). The power output device has a similar arrangement. The external electrode (51) is connected to a primary coil (59) where the other terminal is connected to the ground potential (57).

In our invention, the dusty plasma oscillating between internal electrode (50) and external armature (51) drives an inductively coupled oscillating circuit. The secondary coil (58) is serially connected to the capacitor (56) thus driving a load (84).

It is possible to use several such output circuits in our invention. It is possible to tap the power from an external armature (51) via a so called “Avramenko-plug”, which is a half Graetz rectification circuit. The two diodes (82) are connected to a capacitor (83) as shown in FIG. 13 and are connected parallel to the load (84).

Our invention is applicable to a device having distributed parameter electric circuits. This is based on a circuit powering high-frequency magnetrons (12), as shown in FIG. 10.

It has an acoustic resonator (10), which contains dusty plasma. The cylinder or a sphere resonator is made from quartz or Pyrex (FIG. 8-10). The concentrated parameter circuits of FIG. 8 and FIG. 9 are driven at frequencies of about 10 MHz, by either an inductive coupling (13) or a capacitive coupling having a first electrode (16a) and a second electrode (16b) In FIG. 9, or driven by a capacitor (19) In FIG. 8, or the plasma is driven by a magnetron via waveguide (17) in a cavity resonator (30), which drives the plasma in an acoustic resonator (10) as shown in FIG. 10.

FIG. 8 describes the excitation of an acoustic resonator (10) where the dust particles (1) are charged in the plasma, generated by a solenoid (13) with an inductive coupling using a current resonance. The power supply (40) drives an RF oscillator (12) via wires (41). The oscillator drives the parallel resonant circuit of a solenoid (13) and condenser (19). The device works at sub-atmospheric pressures, under 100-200 Pa. This pressure is generated with a rotary pump preferably, not shown for the sake of simplicity. The shapes of the inlet (14) and outlet ducts (15) are not identical.

The device could typically be driven up to 200 MHz. The acoustic resonator (10) is suitably cylindrical, made of heat resistant glass.

In FIG. 9 the capacitive excitation of the complex plasma is shown. Acoustic cylindrical resonator (10) is placed between the first (16a) and second armatures (16b). A solenoid (13) is necessary for the resonant serial electrical circuit. This layout is also sub-atmospheric, like that shown in FIG. 8.

FIG. 10 is yet another version of our invention based on our process. This is based on the microwave excitation of complex plasma. The acoustic resonator (10) is made of electrically insulating materials. The oscillator (12) radiates into a metal electromagnetic cavity (30) via a waveguide (17). Inlet (14) and outlet tubes (15) lead through the cavity resonator wall (30). In order to fine-tune the maximum oscillation amplitudes of the cavity resonator (10), the inlet tuning opening can be adjusted in both length and diameter.

Multiple devices may be connected in series according to our invention to utilize the nuclear processes, shown in FIG. 11 and FIG. 12. These processes may be influenced by controlling the power input and adding deuterium or Li or Ba to the process in a closely monitored manner.

Our invention is more advantageous for an internal combustion engine if there is a closed circulation circuit, so that the inlet tube (14) of the resonator unit (described earlier in detail) is connected to the exhaust pipe of a buffer (101) of an internal combustion engine (100). The exhaust gas is led into a resonator unit, where its dust particles are decomposed into nano-sized carbon particles and gases. The nano-sized dust particles are removed from the resonators via an exhaust pipe (15). Once the molecular bonds are broken, the hot gases are led into an external combustion engine (like a Stirling engine) then a heat exchanger (300), where the vapor is partially condensed, and removed via a tube (301).

The remaining gas is reintroduced into the air intake (305) of the engine (100), as shown in FIG. 14.

The post advantageous form of our invention is shown in FIG. 14, where the resonator unit, used for decomposition of CO₂, is introduced into a closed circuit of an internal combustion engine. The resonator unit is placed after the internal combustion engine (100) and a buffer vessel (101), in front of a Stirling engine (200). Soot and condensed water are removed at the heat exchanger (300) and water removal duct (301). The O₂ content of the plasma-treated gas is measured by a lambda sensor, placed after the heat exchanger (300). The electric generator (110) is used as an example, which charges the battery bank (111). In this case the amount of circulated N₂ could be decreased as far as the components can tolerate heat stress. Excess oxygen could be admitted into the closed loop from a cylinder (303) containing O₂ via a pressure reducer (304). Thus, a smaller amount of air is necessary via the intake manifold (305) to run the engine (100).

A further advantageous use of our invention connects inlet tube 14 of the resonator unit after the buffer vessel (101) of an internal combustion engine (100) in order to split the CO₂ gas. The exit tube (15) of the resonator unit is connected to an external combustion engine (200), where the exit pipe is connected to a catalytic converter unit (120), as shown in FIG. 15. The open process is shown in FIG. 15, according to our invention when the O₂ content of the split CO₂ molecules are not reintroduced to the intake manifold (305) of the internal combustion engine (100). Instead, the exhaust gases leaving the resonator are led to a catalytic converter (120). The resonator unit is powered by an external combustion engine (200), so the CO₂ emissions are decreased but the fuel consumption is not increased.

A further advantageous use of our invention is shown in FIG. 11, where the resonator unit inlet tube (14) is connected to the buffer (101), in order to split the exhaust CO₂ gas of an internal combustion engine (100), and the exit tube (15) of the resonator unit is connected to a catalytic converter unit (120), as shown in FIG. 16. This is the simplest case of the use of the resonator unit to split the CO₂ content of the exhaust gas. In this form of our invention, the exhaust gases of an internal combustion engine (100) are split in the resonator unit. Then they flow through the catalytic converter (120), and are emitted to the environment. These processes could be initiated by several methods: in the device shown in FIG. 7, we generate plasma in the acoustic resonator (10). Then, fine carbon dust is dispensed into the resonator via inlet opening (14), and the plasma will oscillate loudly. After the introduction of carbon dust, the optimum frequency must be tuned until steady-state temperature is reached at a given working pressure. The same process could be maintained in capacitively excited plasma, shown in FIG. 9. Use of inert gases is not necessary because air is also suitable. The carbon dust does not burn but will disintegrate into smaller particles.

At higher frequencies and pressures, in microwave plasma excitation, about 0.5 gram of fine carbon dust can be introduced into the resonator (10) according to our invention, when there is a maximum field value of the standing wave of the metal cavity resonator (30). However, it is possible to generate dusty plasma by inserting a thin graphite rod into this location, and after some sparking, the plasma oscillations will start.

The dusty plasma shown in FIG. 1 and FIG. 2 is generated by DC current of arc discharge of glow discharge, but without practical application. Then the plasma components around the dust particle are shown in FIG. 5.

However, in our process there will be oscillations according to FIG. 3 and FIG. 4. FIG. 7 portrays the macroscopic pressure distribution in a standing wave or an ion acoustic oscillation in acoustic resonator 10.

Then the plasma has the features shown in FIG. 6. The dust particles in a complex plasma may consist of clusters, each containing several million atoms, typically in the nanometer regime. The material composition, size and shape and efficient manufacturing of the nano-particles are important in the practice. There are only a handful of material compositions for practical purposes, since most metals usually melt at low temperatures and thus are unable to form clusters, while those with high melting points oxidize quickly in a plasma containing oxygen.

In our invention's process, we use carbon or a C+Si carbosilicate mixture as the material for nano-dust. The advantage of carbon is that it does not evaporate even at 4,500° C. but remains in molten form. Another advantage is that it forms clusters easily with itself or with Si especially in a reactive plasma (in air) and will not burn. The structure of complex plasma could be regular, lattice-like, or polycrystalline with regular boundaries, or fluid-like filling a definite partial volume and, obviously, it could also be gas-like. Therefore, complex plasma is very useful in practice but has unique, distinct features not present in ordinary plasma.

Example of the assumed mechanism of CO₂ splitting, according to our invention.

In FIG. 5 the collision of a carbon nano-dust particle (1) is shown with a singly ionized or doubly ionized (2) positive ion CO₂ molecule, and with a neutral CO₂ molecule (22). The neutral CO₂ molecule may decompose for three reasons. Firstly, because positive ions are colliding with neutral CO₂ molecules (22), while accelerating in the electrical field (4) of a dust particle (1). The second reaction could be CO₂⁺+CO₂→2 C+O₂+O₃⁺ due to high-speed collisions and, finally, dissociation due to thermal vibration.

There could be an ionization process for C═C double or multiple chains. In other processes, where neutral CO₂ molecules collide with each other or with a hot dust particle, the bond of some eV potential might split between the oxygen and carbon. Each component of a decomposed molecule may absorb an electron from the surface of the particle. Thus the oxygen might recombine and leave the surface, and the carbon may form longer or short regular chains.

During acoustic oscillations of dust—especially in high-frequency resonances—the collision energies could be high enough to break the chemical bonds of any molecule, such as that between C and O atoms of a CO₂ molecule. The nitrogen molecules and atoms were not shown in FIG. 5, though they are ionized during the collisions, and NO and NO₂ molecules may form.

In FIG. 7 a cylindrical acoustic cavity resonator is shown, where dusty plasma acoustic resonance is created, and a standing pressure wave is shown but without sub and higher harmonics for the sake of simplicity.

In a cavity resonator (10) a pressure difference is generated, whereby the gas flows between the inlet nozzle (14) and outlet nozzle (15). This creates at least two different frequencies for the oscillations but their sum and difference also appear as harmonics. Finally, in FIG. 6, a dust particle (1) is shown in the ambient electric field (25), and a positive ion (24) on its surface like O⁺, or a smaller proton (23).

For the sake of simplicity, three external electric fields were added and shown as a single exciting plane wave (25): the external electromagnetic field, the electrical component of the infrared field and the electric field due to non-equilibrium in the plasma density during oscillations.

The external field (25) has a polarizing effect on a particle (1). Thus, the cloud of electrons (3) is no longer distributed evenly. Due to this polarization, an estimated 10¹¹/cm electric field gradient is formed between the poles of the particle (1). This enormous field is enough to initiate the reaction e⁻+p⁺=n+v, as predicted by Widom and Lassen. The ultra-cold, slow neutrons created this way may participate in several energy producing nuclear reactions mentioned previously. According to our experience, the molecular bonds are broken irreversibly at this high temperature, in a steady flow via a resonator (10) for a proper inlet power density.

We were able to break 3.4 kg CO₂ at a pressure of 1 bar and a temperature of 20° C. with the input of 1 kWh. The exhaust gases of a small 500 cm³ Polski Fiat engine were split at an input power of 500 W when the exhaust CO₂ did not exceed 2% and the CO level was within permissible values. In each case, the energy gain factor exceeded 10, a useful value. The technical use of these results is the subject of our invention, using the electric field amplification by nano-sized dust particles, and its consequent nuclear reactions based on electroweak interactions. Although we cannot rule out other interactions in the plasma, this is a plausible physical mechanism. The calculation of the plasma processes, like the peak values of standing pressure waves at pressure peaks at (11b) is still uncertain. However it does not hinder practical applications.

In our process, we add carbon dust to the existing plasma and the input power is decreased, or we ignite the device so that carbon dust is placed where there is a high electric field intensity of a standing wave and it heats up the device. Then, a dusty plasma is formed in the acoustic resonator, having multiple high-amplitude resonance peaks, adding to it a small amount of hydrogen isotopes. According to our assumption, a Larsen-Widom type process takes place on the surface of the dust particles, which generates nuclear energy.

In our acoustic resonator, the volume of the plasma is about 500 cm³ at ambient pressure and temperature, and at an input of 700-1000 W electric power. For the same amount of plasma, about 70 KW electrical energy input is necessary in the experiment of Sullivan et al, because the microwave absorption efficiency is poor in the absence of oscillating dusty plasma. The technical advantage of our method is that the energy released by the nuclear processes multiplies the input electric energy. Some of the input energy is used to break up molecular bonds (plasma chemistry), and less energy is turned into waste heat compared to other plasma processes used until now. The carbon-based resonant complex plasma may be formed at various geometries and pressures but not at any technical parameters. There is no single parameter which uniquely characterizes the processes to make sure that the same process parameters should take place in another machine.

As this dusty plasma is non-linear and self-organizing, there are chaotic processes as well. Therefore, the plasma jumps erratically from one state to another.

When there is a machine operating under a set of parameters, it will always reproduce the effect but if one changes the geometry, the frequency of the exciting electromagnetic radiation or the acoustic frequencies, or there is a change in the pressure, it may lead to the extinction of the plasma.

We shall describe some technical uses as an example for the decomposition of CO₂. This description is not detailed down to the exact forms and sizes of all possible applications. Perhaps several hundred different machines could be designed. While internal combustion engines could be manufactured from the size of a few cubic ms to several meters continuously without any gap in its size, this is not true for our case. There are only so many “clusters of parameters” at or within which the device will operate efficiently, considerably reducing the range of possible sizes.

The layout of CO₂ thermalizer devices will be shown as an example, to explain the process and devices according to our invention. The advantageous properties of dusty plasma are due to the electric field on the surface of the dust particles and the large amplitude of the plasma resonant oscillations. The technical application of this effect is shown in FIG. 8-FIG. 10.

The plasma state is excited in FIG. 8 with a resonant parallel circuit, with a concentrated parameter circuit, up 200 MHz frequency. This process may be ignited at a pressure of a few hundred Pascals. Then, after reaching steady-state temperature, the pressure could be increased. The power supply (40) drives an oscillator (12) via wires (41), and the oscillator might be built with semiconductors or electron tubes. The oscillator (12) drives a solenoid (13), which couples energy to the plasma, with an oscillating magnetic field. The parallel resonant circuit works well with current resonance. The condenser (19) only stores oscillating electric energy. The acoustic resonator (10) is made from an electrically insulating and heat resisting material. A cylindrical acoustic resonator is the appropriate form for this application.

Inductive plasma heating might be advantageous even at volumes of up to 1-2 m³. Then, it is advantageous to preheat the plasma with an arc discharge.

The serial resonant circuit, shown in FIG. 9, is most advantageous with capacitive plasma excitation. The disadvantage of this process is that, at atmospheric pressure, the circular metal armature plates (16a) and (16b) the distance is about 1-5 mm, since the exciting field is reduced due to charge shielding. It is not worth exceeding 20-30 kV in oscillator voltage, because simple insulators cannot be used above this limit. Thus, the acoustic resonator (10) is short. There are only a few maximum pressure peaks, (11b). To start this effect, it is helpful to preheat the resonator (10) with an arc or glow discharge. This system could be useful for a couple of hundreds of cm³, and at some torrs of initial pressure.

To thermalize a small amount CO₂, a microwave-driven apparatus is needed, as shown in FIG. 10. The disadvantage of this method is that the same cavity is usually not suitable for both an electromagnetic and an acoustic resonator. Therefore, the electromagnetic cavity resonator (30) is not necessarily of the same shape as the acoustic cavity resonator (10). It is important that the electromagnetic cavity resonator should be made of a metal with high electric conductivity, such as silver or copper, but these materials have low melting points and are sensitive to corrosion. Molybdenum would be better, but it is also sensitive to corrosion. Stainless steel is therefore a good compromise. The acoustic resonator (10) should be made of an appropriate, electrically insulating material like quartz, or a heat resistant ceramic compound. Due to the acoustic resonance, there are mechanical stresses, meaning that a wall thickness of at least 1-2 mm is required for the resonator (10). The usual borosilicate glass is not suitable for the resonator (10) due to its low melting point.

Since the plasma itself is conductive, the cavity resonator (30) cannot be designed with the routine methods of communication technology. It is difficult to design a waveguide (17) between the microwave oscillator (12) and the cavity (30) that serves as an impedance transformer. Although a waveguide for microwaves has been invented, in our case it cannot be designed in the straightforward manner known in communication technology.

Otherwise the proper design of microwave guides (17) and cavity resonators (30) is well known to specialists.

A cavity resonator (30) for transversal electromagnetic waves could be designed with a rectangular, cylindrical or spherical shape. The latter has a disadvantage, because it is difficult to construct a proper view window on its surface, and it is more expensive to make a spherical resonator.

The acoustic cavity resonator (10) must be placed within the electromagnetic cavity (30) to the spot where the intensity of the standing electrical wave is the highest.

One appropriate construction according to our invention is shown in FIG. 11. It features a spherical acoustic resonator (19) with an exit valve (20). This way, a Helmholtz resonator is where an inlet valve (21) also influences the acoustic frequencies. The material to be decomposed flows in through a valve (21) with nano-dust particles (1), which are necessary for the complex plasma to be formed. It is important that the acoustic resonator should be as close to spherical in shape as possible to maximize the oscillation amplitude.

The acoustic resonator (10) cannot be placed at the bottom of the cavity resonator (30), since the maximum amplitude of the electromagnetic standing waves is somewhere inside cavity (30) but not in its geometric center. The support leg (18) should be made of a hard material to minimize the damping of oscillations so the amplitude of the acoustic oscillation is not diminished.

The diameter of an acoustic spherical oscillator is kept between 5-15 cm. With a larger diameter, microwaves cannot penetrate deeper into the plasma at the usual 1 kW power level. Therefore, the middle of the plasma cannot be excited. A smaller diameter is not suitable because of the small volume. It is made of quartz or ceramic.

If the gas to be thermalized—i.e. CO₂—has too high a velocity, the plasma will escape from the acoustic resonator (10). Therefore, the efficiency of the process decreases, and the metal resonator (30) melts. The arrangement in FIG. 11 (as an example of our invention) is operated with a magnetron for continuous operation at a frequency range of 2-5 GHz. At higher frequencies, other oscillators, such as traveling wave tubes or giratrons, could be used but at higher power, but they are much less efficient. Electromagnetic waves above 2 GHz could be used since there is no need for preheating. While more difficult to manufacture, a spherical resonator (10) is more suitable than a cylindrical resonator (10) due to its smaller relative volume.

The usual linear acoustic medium rules cannot be followed for the design of the inlet (20) and outlet (21) valves. The length and diameter of valves (20, 21, 32) or further cylindrical openings will influence the number and amplitudes of dusty, plasma acoustic oscillations. The spherical or cylindrical volume of an acoustic resonator (10) is the spring, and the mass in the valve is the oscillating system. The complex plasma is nonlinear as a spring. Our system is strongly nonlinear so the system works efficiently only within a narrow set of parameters.

The electromagnetic resonator (30) should have a polished, mirror-like inner surface, regardless of its shape. This is necessary to reflect the infrared, visible and ultraviolet rays of the oscillating plasma, so that nano-sized particles (1) are re-radiated, improving the efficiency of the system. The glass tube (29) is necessary for the same reason. During operation, it serves as a heat insulator for the acoustic resonator (10), so that it will lose less heat. Therefore, less energy input is necessary to maintain the plasma. Reactive ions leaving the acoustic resonator (10) via valves (20) and (21) will not corrode the inner polished surface of resonator (30).

The most important parameters during thermalization are the following: the power input of the oscillator (12) (adjustable during operation), the inlet mass flux of the gas, (CO₂ as an example) at the value where the plasma does not leave the acoustic resonator (10), the pressure in the device, the density of the nano-dust, and, lastly, the amount of hydrogen isotopes in the system.

A spherical layout of the system is shown in FIG. 12, which works according to the parameters shown in FIG. 11, but with both resonators (10) and (30) being spherical in shape. The inner surface (31) of the resonator (30) is also mirror-like. This fine surface is surrounded by a spherical quartz layer (33) to protect its surface (31).

Inlet tube (14) and outlet tube (15) are led through the metal walls of the resonator (30) to let in and out CO₂ or H₂O gases to be thermalized. The ignition and operating temperature, at a pressure of about 1 bar, is around 2,000° C. inside the acoustic resonator (10).

Another suitable method using our invention is shown in FIG. 13, which is operated at frequencies of some MHz and at some 100 Pa.

The capacitive operation is quite suitable, because high electric field intensities are achieved between the carbon-coated cathode (50) and the external electrode (51). (For simplicity, the gas inlet tube and vacuum pump outlet are not shown).

The salient feature of this layout is the “Avramenko plug” which should be operated below 10 MHz. The wire (81) is connected to diodes (82) as a “half Graetz” connection, which is joined to the condenser (83) and the load (84).

When the plasma oscillates and excess heat energy is generated, high-amplitude oscillations are detected on the external electrode (51). They are captured by the low frequency “Avramenko plug” and with the oscillating circuits containing a ferrite core or air core transformers. Only one is shown for the sake of simplicity (27).

One terminal of the primary coil (59) absorbs the oscillation energy of the external electrode (51), while the other terminal is connected to the ground potential (57). The secondary coil (58) is connected to tuning capacitor (56) of the tuning circuit, and this circuit has load (84).

The layout of one version our invention is shown in FIG. 13. Its frequency is adjusted by a variable capacity condenser (56). The electric potential of the inner electrode (52) is set by a wire, conducted via an insulator (52), and it secures its position mechanically. This system may work at hundreds of degrees C. so it is simple to build and operate. It has a lower specific power per volume than those shown in FIG. 11 and FIG. 12. The pressure should be set so that we maximize the number of standing waves between the inner electrode (50) and the external electrode (51). Most of the heat is generated at the (11a) crest of a standing wave, because the electric field gradient is the maximum between the dust particles (1), and their polarization (shown in FIG. 7). There will be “hot” and “cold” locations within a quarter wavelength of a standing wave. The cold locations are the (11b) pressure maxima, where the pressure and electric field gradient is zero. This could be made visible with a high-speed camera using a low aperture setting.

There is a wide range of microwave oscillators like magnetrons and giratrons for different frequencies and power, though magnetrons are the more practical. While power is transformed and transported from the power supply (40) via a wire (40) to the oscillator (12) and waveguide (17), a careful impedance matching is necessary to minimize power loss (this is public domain know-how).

We discovered that oscillating complex plasma is suitable for the thermalization of molecules like CO₂. This is possible because, with high-amplitude plasma oscillations, some frequencies approach the rotation and translation frequencies of CO₂ molecules. In the radial electric field of dust particles (1) the positive ions (2) of the CO₂ molecules are accelerated, as a result of which the oxygen atoms break down from the molecules. The process is mainly irreversible since carbon atoms tend to arrange into clusters, forming a fine carbon dust, collected at the end of the process. It is important to maintain the presence of dust particles (1).

1. Renewable energy production process with resonant nano-dust plasma, with the application of a cavity resonator and an acoustic resonator—characterized by having the acoustic resonator placed inside the cavity resonator, thus creating a resonator unit—as well as a series of acoustic resonances created above 120 dB in the frequency spectrum of 5 Hz - 5 GHz, at temperatures ranging between 1,000° C.-3.000° C. and averaging at 2.000° C., with sub-micron sized carbon dust particles at the hundred-nanometer scale and a total carbon mass of less than 0.5 g, and by less than 1% mass ratio of hydrogen isotopes and, advantageously, from air or from 1% hydrogen and helium mixture, where the external exciting field has a power density of less than 2,000 W/dm³ and the electromagnetic waves are reflected from the cavity resonator walls, thereby creating oscillations on the surface of carbon dust particles, causing electric field amplification, thus yielding energy production and nuclear transmutation processes with plasmon polariton oscillating between 10 kHz-5 GHz and in the terahertz range, producing heat or electric energy, or creating a series of nuclear transmutations.

2. Renewable heat generation device developed from a cavity resonator excited by electromagnetic waves and an acoustic cavity resonator, where nano-sized dust particles oscillate at a number frequencies characterized by rectangular or cylindrical cavity resonators having mirror-like internal surfaces, inside which an acoustic resonator made of electrically insulating and refractory material is placed, where this resonator has at least one tuning , suitably of cylindrical shape, on both inlet and outlet sides, and features support legs made of insulating material; moreover, the acoustic resonator is sheathed in a transparent heat-insulating tube, in order to allow the acoustic resonator to be heated to an average temperature of at least 2,000° C., at atmospheric or higher pressure, via a wave guide connected to an oscillator generating electromagnetic waves at frequencies exceeding 1 GHz.

3. Renewable heat producing device, formed by a cavity resonator excited by electromagnetic fields, and an acoustic resonator with a number of acoustic resonances, in which the resonating plasma contains nano-sized dust particles; characterized by a spherical electromagnetic cavity resonator containing a spherical acoustic cavity resonator, where the electromagnetic metal cavity resonator has mirror-like internal walls covered by a transparent heat resistant glass, where the acoustic resonator is suitably made of heat resistant ceramic material and is mounted on insulating legs, and features at least one tuning for inlet and outlet sides each, operating at or above atmospheric pressure and at a minimum average temperature of 2,000° C.

4. Renewable electric energy producing device working with resonant dusty plasma in co-spherical inner and outer electrodes, whereby the inner electrode is connected to the power supply and the outer electrode to the load, with the input power supplied by a power source, oscillator, primary and secondary coils, the load is connected to the outer electrode via oscillating circuits; characterized by an inner electrode made of carbon or carbosilicates working in frequencies ranging from a few kHz to a few MHz, connected to one terminal of the secondary-side transformer, while the other terminal is grounded, and insulated from the outer electrode—which is spherical in shape and features a mirror-like inner surface sheathed with an electrically insulating and heat resistant layer; furthermore, the device works at about 20 Pa and is operated suitably at a maximum temperature of 500° C., further the outer electrode is connected to tuned oscillating circuits via a single wire.

5. Energy production device with concentrated parameters and comprising an oscillator and a resonant circuit, also containing an acoustic resonator with dust particles, characterized by a quartz or Pyrex cylindrical or spherical acoustic resonator up to 10 MHz frequency coupled to the oscillating, capacitively or inductively driven plasma with resonant oscillating circuits or by another arrangement whereby an acoustic resonator is driven inside a cavity resonator driven via a waveguide.

6. Equipment according to claim 2 characterized by an adjustable inlet nozzle of variable length and diameter allowing for the fine-tuning of the maximum number of acoustic resonance peaks inside the acoustic cavity resonator.

7. A process for renewable energy production with resonant nano-dust plasma, with the application of a cavity resonator and an acoustic resonator—characterized by having the acoustic resonator placed inside the cavity resonator, thus creating a resonator unit—as well as a series of acoustic resonances created above 120 dB in the frequency spectrum of 5 Hz - 5 GHz, at temperatures ranging between 1,000° C.-3.000° C. and averaging at 2.000° C., with sub- micron sized carbon dust particles at the hundred-nanometer scale and a total carbon mass of less than 0.5 g, and by less than 1% mass ratio of hydrogen isotopes and, advantageously, from air or from 1% hydrogen and helium mixture, where the external exciting field has a power density of less than 2,000 W/dm³ and the electromagnetic waves are reflected from the cavity resonator walls, thereby creating oscillations on the surface of carbon dust particles, causing electric field amplification, thus yielding energy production and nuclear transmutation processes with plasmon polariton oscillating between 10 kHz-5 GHz and in the terahertz range, producing heat or electric energy, or creating a series of nuclear transmutations, wherein said cavity resonator and acoustic resonator are devices according to claim 2, to influence the quality of the nuclear transmutations, with deuterium, lithium and boron added in a controlled manner, as well as by the tuning of acoustic frequencies.

8. Method described by claim 1, characterized by a closed circulation loop in such a manner, that the inlet of a resonator unit is connected to the exit tube of an internal combustion engine and a buffer, thus the exhaust gases pass through a resonator unit where they are thermalized into nano-sized carbon dust particles and gases, further the nano-sized dust is then channeled away via an exit tube, while the hot gases are led through a Sterling motor and a heat exchanger where water is partly condensed and removed from the system via an , while the remaining gas is re-admitted to the intake manifold of the internal combustion engine.

9. Device according to claim 2, characterized by a resonator unit connected to the exit tube of a buffer from an internal combustion engine in order to thermalize the exit CO₂ gas, where the exit of the said resonator unit is connected to the intake of an external combustion engine, where outlet is connected to a catalytic converter.

10. Device according to claim 2, characterized by a resonator unit which is connected to the exit tube of a buffer from an internal combustion engine in order to thermalize the exit CO₂ gas, and the output of the resonator unit is led into a catalytic converter.

11. Equipment according to claim 3 characterized by an adjustable inlet nozzle of variable length and diameter allowing for the fine-tuning of the maximum number of acoustic resonance peaks inside the acoustic cavity resonator.

12. Equipment according to claim 5 characterized by an adjustable inlet nozzle of variable length and diameter allowing for the fine-tuning of the maximum number of acoustic resonance peaks inside the acoustic cavity resonator.

13. A process for renewable energy production with resonant nano-dust plasma, with the application of a cavity resonator and an acoustic resonator—characterized by having the acoustic resonator placed inside the cavity resonator, thus creating a resonator unit—as well as a series of acoustic resonances created above 120 dB in the frequency spectrum of 5 Hz-5 GHz, at temperatures ranging between 1,000° C.-3.000° C. and averaging at 2.000° C., with sub-micron sized carbon dust particles at the hundred-nanometer scale and a total carbon mass of less than 0.5 g, and by less than 1% mass ratio of hydrogen isotopes and, advantageously, from air or from 1% hydrogen and helium mixture, where the external exciting field has a power density of less than 2,000 W/dm³ and the electromagnetic waves are reflected from the cavity resonator walls, thereby creating oscillations on the surface of carbon dust particles, causing electric field amplification, thus yielding energy production and nuclear transmutation processes with plasmon polariton oscillating between 10 kHz-5 GHz and in the terahertz range, producing heat or electric energy, or creating a series of nuclear transmutations, wherein said cavity resonator and acoustic resonator are devices according to claim 3 to influence the quality of the nuclear transmutations, with deuterium, lithium and boron added in a controlled manner, as well as by the tuning of acoustic frequencies.
